(19) United States
(12) Patent Application Publication
(10) Pub. No.: US 2026/0229037 A1
(43) Pub. Date: Aug. 6, 2026

(54) IMAGE PROCESSING DEVICE, IMAGE PROCESSING METHOD, AND RECORDING MEDIUM

(71) Applicant: NEC Corporation, Tokyo (JP)

(72) Inventors: Ryuhei ANDO, Tokyo (JP); Toru TAKAHASHI, Tokyo (JP); Takashi SHIBATA, Tokyo (JP)

(73) Assignee: NEC Corporation, Tokyo (JP)

(21) Appl. No.: 19/454,681

(22) Filed: Jan. 21, 2026

(30) Foreign Application Priority Data
Jan. 31, 2025 (JP) 2025-014747

(51) Int. Cl. G06V 20/52; G06V 10/70; G06V 10/764; G06V 10/776; G06V 10/82; G06V 40/20

(52) U.S. Cl. CPC G06V 20/52; G06V 10/764; G06V 10/768; G06V 40/20; G06V 10/776; G06V 10/82

(57) ABSTRACT

In an image processing device, a multi-camera image acquisition means acquires images from multiple cameras. A person detection means detects persons from the images of the multiple cameras. A person behavior recognition means performs behavior recognition of the persons from the images of the multiple cameras. An inter-camera person integration means performs identification of identical persons among the images of the multiple cameras. A behavior recognition result integration means integrates the results of the behavior recognition based on the results of the behavior recognition and the results of the identification of the identical persons.

### INCORPORATION BY REFERENCE

This application is based upon and claims the benefit of priority from Japanese patent application No. 2025-014747, filed on Jan. 31, 2025, the disclosure of which is incorporated herein in its entirety by reference.

### TECHNICAL FIELD

The present disclosure relates to a technique of behavior recognition.

### BACKGROUND ART

There is known a technique for performing behavior recognition of a person appearing in camera images using a model based on deep learning. For example, Patent Document 1 proposes a technique for improving the accuracy of behavior recognition by extracting a specific image for performing behavior recognition of a target person from video data.

Patent Document 1: JP 2019-185752 A

### SUMMARY

However, in the method of Patent Document 1, the recognition accuracy may decrease depending on the angles of the cameras.

One object of the present disclosure is to provide an image processing device capable of accurately executing behavior recognition of a person appearing in images.

According to an example aspect of the present invention, there is provided an image processing device, including:
at least one memory configured to store instructions; and
at least one processor configured to execute the instructions to:
acquire images from multiple cameras;
detect persons from the images of the multiple cameras;
perform behavior recognition of the persons from the images of the multiple cameras;
perform identification of an identical person among the images of the multiple cameras; and
integrate results of the behavior recognition based on the results of the behavior recognition and a result of the identification of the identical person.

According to another example aspect of the present invention, there is provided an image processing method including:
acquiring images from multiple cameras;
detecting persons from the images of the multiple cameras;
performing behavior recognition of the persons from the images of the multiple cameras;
performing identification of an identical person among the images of the multiple cameras; and
integrating results of the behavior recognition based on the results of the behavior recognition and a result of the identification of the identical person.

According to a further example aspect of the present invention, there is provided a recording medium recording a program for causing a computer to execute processing including:
acquiring images from multiple cameras;
detecting persons from the images of the multiple cameras;
performing behavior recognition of the persons from the images of the multiple cameras;
performing identification of an identical person among the images of the multiple cameras; and
integrating results of the behavior recognition based on the results of the behavior recognition and a result of the identification of the identical person.

According to the present disclosure, it is possible to accurately execute behavior recognition of a person appearing in images.

### BRIEF DESCRIPTION OF THE DRAWINGS

FIG. 1 is a diagram conceptually illustrating an image processing device;

FIG. 2 is an example of a worksite and installation locations of cameras;

FIG. 3 is a block diagram illustrating a hardware configuration of an image processing device according to the present disclosure;

FIG. 4 is a block diagram illustrating a functional configuration of an image processing device according to the present disclosure;

FIG. 5 is a diagram for describing processing of an inter-camera person integration unit;

FIG. 6 is a diagram for describing processing of a 3D person position estimation unit;

FIG. 7 is a diagram for describing processing of a person matching processing unit;

FIG. 8 is a diagram for describing processing of a behavior recognition result integration unit;

FIG. 9 is a flowchart of processing of the image processing device according to the present disclosure;

FIG. 10 is a block diagram illustrating a functional configuration of an image processing device according to a modification 2;

FIG. 11 is a diagram for describing a modification 3;

FIG. 12 is a diagram for describing a modification 4;

FIG. 13 is a block diagram illustrating a functional configuration of another image processing device according to the present disclosure; and

FIG. 14 is a flowchart of processing of the other image processing device according to the present disclosure.

### EXAMPLE EMBODIMENTS

Hereinafter, preferred example embodiments of the present disclosure will be described with reference to the drawings.

### First Example Embodiment

### Schematic Configuration

At worksites such as construction, heavy industry, warehouses, and manufacturing, efforts have been made to optimize human resources, such as recognizing work of site workers, converting the work into data by grasping the situation one by one, and leading to work improvement. For this reason, the technology of behavior recognition of persons appearing in an image is important as a technology capable of converting behaviors of the persons into data from the image. In conventional behavior recognition, a single-angle camera image is input to perform behavior recognition of persons appearing in the image. However, in a case where a shelf, a heavy machine, or the like hides a person (occlusion occurs), in a case where a person is working with his/her back to the camera, in a case where tracking fails due to multiple persons passing by each other and the path is broken, or the like, accuracy of behavior recognition may decrease depending on the angle of the camera. Therefore, in the present example embodiment, behavior recognition of a person is performed based on images captured by multiple cameras. As a result, the accuracy of behavior recognition can be improved.

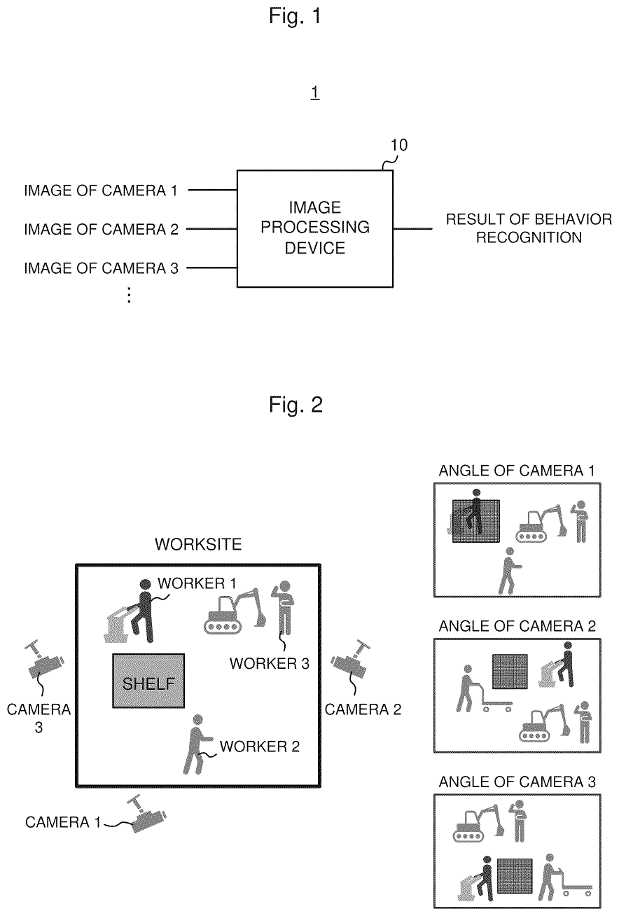

FIG. 1 is a diagram conceptually illustrating an image processing device according to the present example embodiment. An image processing device 10 receives images captured by multiple cameras as input, and performs behavior recognition of persons appearing in the images. In the present example embodiment, three cameras including a camera 1, a camera 2, and a camera 3 are used as the multiple cameras.

FIG. 2 is an example of a worksite and installation locations of the cameras. As illustrated in FIG. 2, a camera 1, a camera 2, and a camera 3 are installed at a worksite. In addition, it is assumed that a worker 1, a worker 2, and a worker 3 are working at the worksite. From the angle of the camera 1, the worker 1 is hidden behind the shelf, and it is difficult to recognize the worker 1. In addition, the worker 2 pushes a hand truck with his/her back to the camera 1, and the hands and the hand truck are invisible. In contrast, from the angles of the camera 2 and the camera 3, the worker 3 operating a heavy machine and the worker 2 pushing the hand truck are visible. The image processing device 10 according to the present example embodiment performs behavior recognition of the workers appearing in cameras and integrates the results. Therefore, for example, even in a situation where the behavior recognition fails only from the angle of the camera 1, the behavior recognition can be correctly performed.

### Hardware Configuration

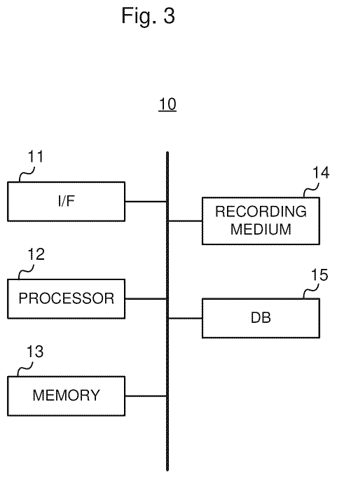

FIG. 3 is a block diagram illustrating a hardware configuration of the image processing device 10 according to the first example embodiment. As illustrated in the figure, the image processing device 10 includes an interface (I/F) 11, a processor 12, a memory 13, a recording medium 14, and a database (DB) 15.

The I/F 11 exchanges data with an external device. Specifically, the I/F 11 acquires images captured by the respective cameras from the camera 1, the camera 2, and the camera 3.

The processor 12 is a computer such as a central processing unit (CPU), and takes overall control of the image processing device 10 by executing a program prepared in advance. The processor 12 may be a graphics processing unit (GPU), a digital signal processor (DSP), a micro processing unit (MPU), a floating point number processing unit (FPU), a physics processing unit (PPU), a tensor processing unit (TPU), a quantum processor, a microcontroller, or a combination thereof. The processor 12 executes behavior recognition integration processing to be described later.

The memory 13 includes a read only memory (ROM), a random access memory (RAM), and the like. The memory 13 is also used as a work memory during execution of various types of processing by the processor 12.

The recording medium 14 is a non-volatile non-transitory recording medium, such as a disk-shaped recording medium, a semiconductor memory, and is detachable from the image processing device 10. The recording medium 14 records various programs to be executed by the processor 12. In a case where the image processing device 10 executes various types of processing, a program recorded in the recording medium 14 is loaded into the memory 13, and is executed by the processor 12. The DB15 stores, for example, a result of behavior recognition integration processing to be described later.

In addition to the above, the image processing device 10 may include a display device such as a liquid crystal display and an input device such as a keyboard and a mouse. The display device and the input device are used by an administrator of the image processing device 10 to perform necessary management, for example.

### Functional Configuration

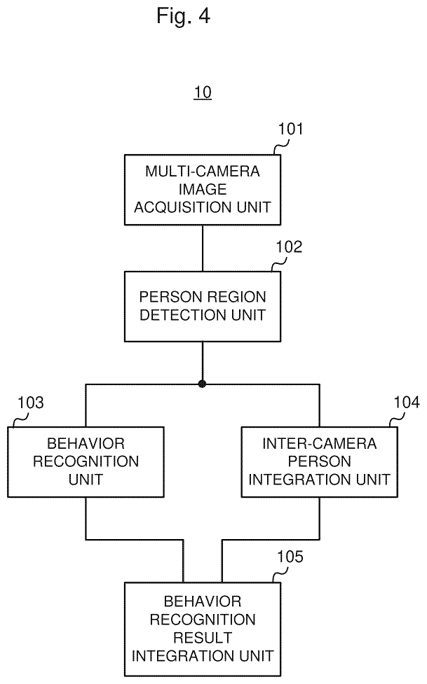

FIG. 4 is a block diagram illustrating a functional configuration of the image processing device 10 according to the first example embodiment. The image processing device 10 functionally includes a multi-camera image acquisition unit 101, a person region detection unit 102, a behavior recognition unit 103, an inter-camera person integration unit 104, and a behavior recognition result integration unit 105.

The multi-camera image acquisition unit 101 acquires images captured by the respective cameras (hereinafter, also referred to as “captured images”) from the camera 1, the camera 2, and the camera 3. The multi-camera image acquisition unit 101 outputs the captured images of the respective cameras to the person region detection unit 102.

The person region detection unit 102 detects the region of each person from the captured image of each camera. For example, the person region detection unit 102 can detect the region of each person using a deep learning model such as You Only Look Once (YOLO). The person region detection unit 102 surrounds the region of each detected person with a rectangle or the like, and outputs the captured images of the respective cameras and the rectangle information thereof to the behavior recognition unit 103 and the inter-camera person integration unit 104. The rectangle information indicates a position of the rectangle in the captured image. Hereinafter, a person detected from the captured image of each camera is also referred to as a “person captured by each camera”.

The behavior recognition unit 103 recognizes behavior of each person captured by each camera. For example, the behavior recognition unit 103 can recognize the behavior of each person by using a deep learning model such as an Actor Context Actor Relation (ACAR). The behavior recognition unit 103 outputs results of the behavior recognition to the behavior recognition result integration unit 105.

Note that ACARs are described in the following literature. The following literature is incorporated herein as references.
Pan, J., et al.: Actor-context-actor relation network for spatio-temporal action localization. In Proceedings of the Conference on Computer Vision and Pattern Recognition (CVPR). pp.464-474 (2021).

The inter-camera person integration unit 104 assigns an identification (ID) to each person captured by each camera. The ID is information for identifying each person. The inter-camera person integration unit 104 assigns an identical ID to each identical person.

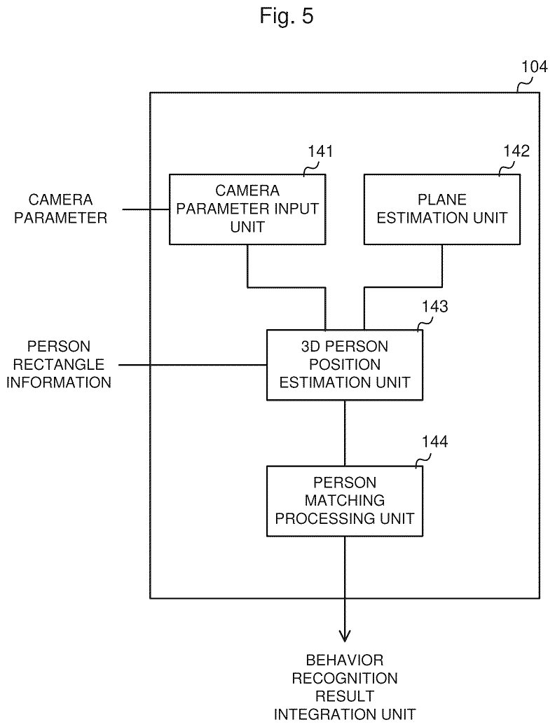

FIG. 5 is a diagram for describing processing by the inter-camera person integration unit 104. The inter-camera person integration unit 104 includes a camera parameter input unit 141, a plane estimation unit 142, a 3D person position estimation unit 143, and a person matching processing unit 144.

The camera parameter input unit 141 receives parameters of each camera. Examples of the camera parameters include camera external parameters (position, attitude, and the like of camera) and camera internal parameters (focal length of lens, position of optical axis, and the like). The parameters of each camera are obtained in advance, for example, by performing camera calibration. The camera parameter input unit 141 outputs parameters of each camera to the 3D person position estimation unit 143.

The plane estimation unit 142 receives three-dimensional point cloud data representing the three-dimensional shape of the worksite. The three-dimensional point cloud data is obtained in advance by reconstructing the three-dimensional structure from the images captured by the respective cameras. The plane estimation unit 142 estimates a plane (that is, a plane in a three-dimensional space) corresponding to the floor of the worksite based on the three-dimensional point cloud data. For example, the plane estimation unit 142 can estimate the plane in the three-dimensional space from the three-dimensional point cloud data using Random Sample Consensus (RANSAC). The plane estimation unit 142 outputs the estimated plane to the 3D person position estimation unit 143.

The 3D person position estimation unit 143 receives rectangle information of each person captured by each camera from the person region detection unit 102. Furthermore, the 3D person position estimation unit 143 receives parameters of each camera from the camera parameter input unit 141, and receives the plane in the three-dimensional space from the plane estimation unit 142.

The 3D person position estimation unit 143 estimates the position of each person captured by each camera in the three-dimensional space, and outputs the position to the person matching processing unit 144.

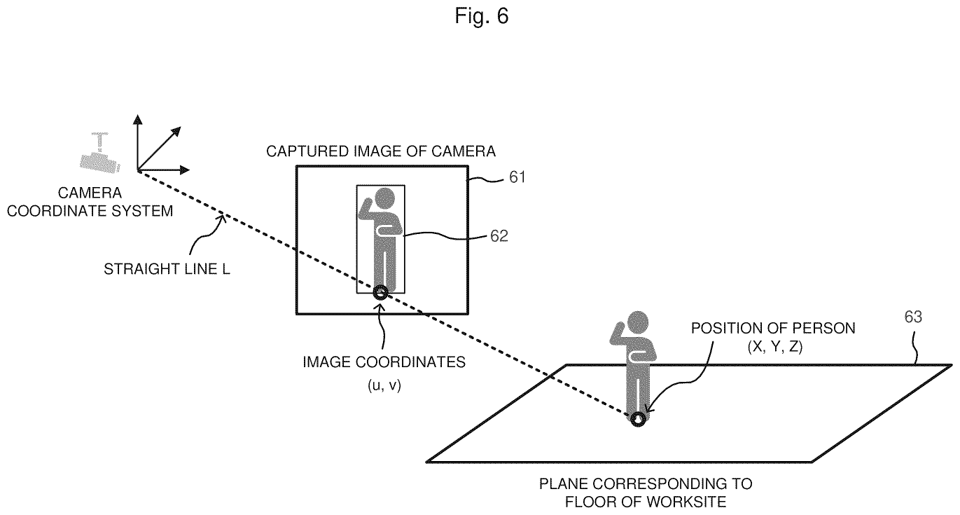

FIG. 6 is a diagram for describing processing of the 3D person position estimation unit 143. Note that a camera image 61 in the figure indicates an image captured by the camera. The person rectangle 62 indicates rectangle information of the person detected from the camera image 61. A plane 63 indicates a plane in the three-dimensional space estimated by the plane estimation unit 142.

First, the 3D person position estimation unit 143 estimates a straight line L from the origin of the camera coordinate system (the position of the camera) toward the image coordinates of the person (u, v). For example, the 3D person position estimation unit 143 can convert the point (u, v) in the image coordinate system of the person into a direction vector (Xc, Yc, Zc) in the camera coordinate system by using the perspective projection model. This direction vector represents the direction of the straight line L from the origin of the camera coordinate system toward the image coordinates (u, v). The 3D person position estimation unit 143 can estimate the straight line L based on this direction vector. Next, the 3D person position estimation unit 143 estimates where the person is located on the plane 63. For example, the 3D person position estimation unit 143 obtains an intersection (X, Y, Z) between the plane 63 and the straight line L using an equation (ax+by+cz+d=0) of the plane in the space. Then, the 3D person position estimation unit 143 estimates the obtained intersection as the position of the person.

In this manner, the 3D person position estimation unit 143 estimates the position of the person captured by each camera. Then, the 3D person position estimation unit 143 converts the position of the person in the camera coordinate system into the position in the world coordinate system by using the parameters of each camera. The world coordinate system is a coordinate system corresponding to the entire worksite.

In a case where the worksite is not a flat surface, the plane estimation unit 142 may estimate not a plane but a mesh structure or the like from the three-dimensional point cloud data, and the 3D person position estimation unit 143 may estimate an intersection of a straight line and a mesh as a position of a person.

Note that the method for estimating the position of the person described above is an example, and the method is not limited thereto. The 3D person position estimation unit 143 may use any method in addition to the above-described method, as long as the position of the person in the three-dimensional space can be estimated. For example, the 3D person position estimation unit 143 may estimate the depth of the person from the camera image 61 using a deep learning-based model, and use the depth information for the position estimation of the person.

Furthermore, in FIG. 6, the 3D person position estimation unit 143 defines the center point of the bottom side of the person rectangle as the image coordinates (u, v) of the person. However, instead of that, the 3D person position estimation unit 143 may estimate the skeleton or the like of the person and define a point at the feet of the person as image coordinates (u, v) of the person. The skeleton of the person can be estimated from the captured image of each camera by using, for example, a skeleton estimation model based on deep learning. Furthermore, the 3D person position estimation unit 143 may estimate the position of the person not only using the feet as a mark but also using the head as a mark. For example, the 3D person position estimation unit 143 converts the coordinates of the head in the image coordinate system into coordinates thereof in the camera coordinate system. Then, the 3D person position estimation unit 143 draws a straight line vertically downward from the head and obtains an intersection of the straight line and the plane 63 as the position of the person. Note that the 3D person position estimation unit 143 assumes the height of the person in advance.

Returning to FIG. 5, the person matching processing unit 144 assigns an ID to each person captured by each camera. At this time, the person matching processing unit 144 determines whether persons captured by the cameras include identical persons based on the positions of the persons input from the 3D person position estimation unit 143, and assigns an identical ID to each identical person. The person matching processing unit 144 outputs the positions of persons and the IDs of the persons to the behavior recognition result integration unit 105.

Specifically, the person matching processing unit 144 selects two cameras from the multiple cameras. The person matching processing unit 144 calculates a Euclidean distance (L2 distance) between the position of a person captured by one camera and the position of a person captured by the other camera. Then, the person matching processing unit 144 determines whether the person captured by one camera and the person captured by the other camera are an identical person based on the L2 distance. The person matching processing unit 144 assigns an identical ID to the person determined to be the identical person. The person matching processing unit 144 executes the above processing between the adjacent cameras, and ends the processing when all the cameras are selected at least once. This associates the persons each included in the captured image of every camera with each other.

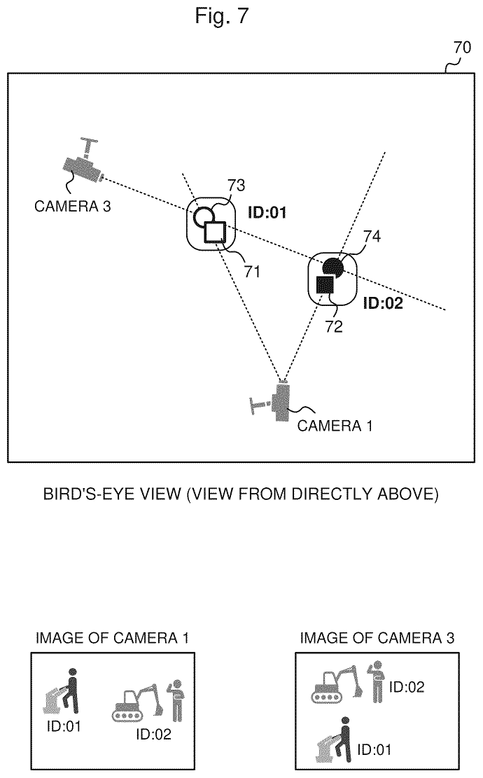

FIG. 7 is a diagram for describing processing of the person matching processing unit 144. In FIG. 7, it is assumed that the camera 1 and the camera 3 are selected from the camera 1, the camera 2, and the camera 3. A bird's-eye view 70 in the figure is a view of a three-dimensional worksite viewed from above. In the bird's-eye view 70, the position of the person input from the 3D person position estimation unit 143 is plotted. The person 71 and the person 72 indicate positions of persons captured by the camera 1. The person 73 and the person 74 indicate positions of persons captured by the camera 3.

The person matching processing unit 144 calculates an L2 distance between the person 71 and the person 73, an L2 distance between the person 71 and the person 74, an L2 distance between the person 72 and the person 73, and an L2 distance between the person 72 and the person 74. Then, the person matching processing unit 144 performs Hungarian matching with the L2 distances as costs, and associates the positions of the persons captured by the camera 1 with the positions of the persons captured by the camera 3 so as to minimize the costs. In FIG. 7, the person 71 and the person 73 are associated with each other and the person 72 and the person 74 are associated with each other as a result of the Hungarian matching. The person matching processing unit 144 determines that the person 71 and the person 73 are an identical person, and assigns an identical ID “01” to the identical person. In addition, the person matching processing unit 144 determines that the person 72 and the person 74 are an identical person, and assigns an identical ID “02” to the identical person.

The person matching processing unit 144 determines whether the persons are an identical person based on the positions of the persons. However, in addition to this, the person matching processing unit 144 may determine whether the persons are an identical person by using information such as moving speeds, moving directions, and appearance characteristics of the persons.

Note that the above-described method for determining whether the persons are an identical person is an example, and the method is not limited thereto. The person matching processing unit 144 may use any method as long as it can determine whether persons respectively captured by multiple cameras are an identical person and assign an identical ID to the identical person. For example, in the above-described method, the person matching processing unit 144 selects two cameras from the multiple cameras and performs the determination processing for each pair of cameras. Instead, the person matching processing unit 144 may use a method of assigning an identical ID to the identical person using a graph optimization method by using each camera as a node and using each correspondence relationship based on a result of the Hungarian matching between the cameras as an edge.

Note that the inter-camera person integration unit 104 can also acquire appearance characteristics of each person from an RGB image by using a method such as Person Re-Id (re-identification) to identify the person. However, at the worksite, the appearance characteristics of the persons are all the same due to wearing of the same work clothes, helmet, hat, or the like, and thus the person identification may fail. Therefore, the inter-camera person integration unit 104 performs person identification not depending on appearance characteristics, by using the above-described method.

Returning to FIG. 4, the behavior recognition result integration unit 105 receives the results of the behavior recognition of the persons captured by the cameras from the behavior recognition unit 103. Furthermore, the behavior recognition result integration unit 105 receives the IDs of the persons captured by the cameras from the inter-camera person integration unit 104.

The behavior recognition result integration unit 105 integrates the results of the behavior recognition for each person based on the results of the behavior recognition of the persons captured by the cameras and the IDs of the persons captured by the cameras, and outputs the integrated result.

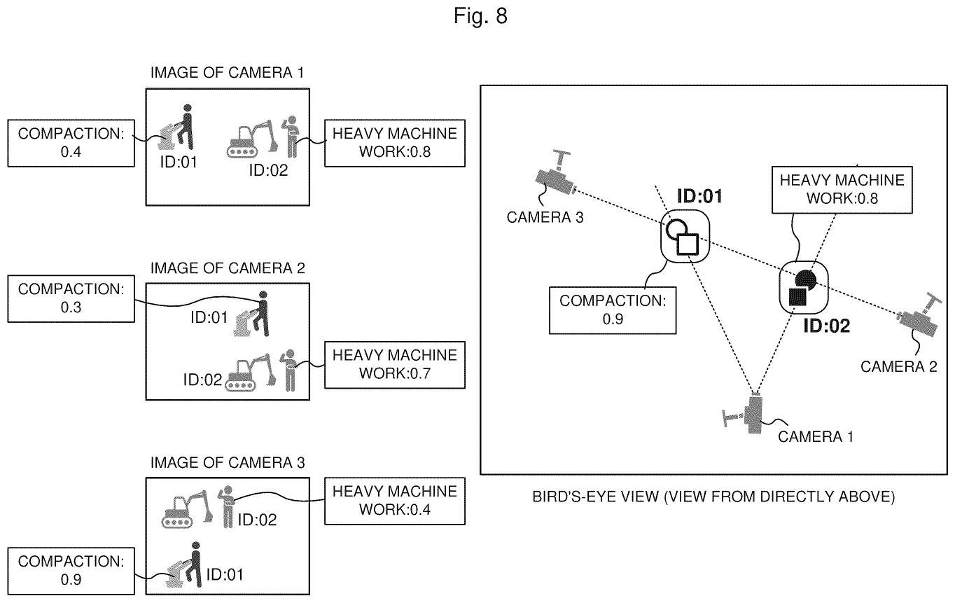

FIG. 8 is a diagram for describing processing of the behavior recognition result integration unit 105. Note that the image of the camera 1, the image of the camera 2, and the image of the camera 3 in FIG. 8 are captured at the same time. In addition, IDs and results (labels and scores) of behavior recognition are assigned to persons appearing in the image of each camera.

In FIG. 8, regarding the person with ID“01”, the results of behavior recognition estimated from the images of the respective cameras are “compaction: 0.4”, “compaction: 0.3”, and “compaction: 0.9” in the order of the camera 1 to the camera 3. The behavior recognition result integration unit 105 adopts “compaction: 0.9” having the highest score (that is, having the highest reliability) among the results of the behavior recognition, as the final integration result. In addition, in FIG. 8, the results of the behavior recognition estimated from the images of the respective cameras for the person with ID“02” are “heavy machine work: 0.8”, “heavy machine work: 0.7”, and “heavy machine work: 0.4” in order of the camera 1 to the camera 3. The behavior recognition result integration unit 105 adopts “heavy machine work: 0.8” having the highest score among the results of the behavior recognition, as the final integration result.

As described above, the behavior recognition result integration unit 105 collectively aggregates the results of the behavior recognition of each identical person with different appearances captured by the multiple cameras, making it possible to select the most likely result of the behavior recognition and to improve the accuracy of the behavior recognition.

Note that, in FIG. 8, the behavior recognition result integration unit 105 integrates the results of the behavior recognition of the camera 1 to the camera 3. However, some cameras may be selected from all the cameras, and the results of the behavior recognition of the selected cameras may be integrated, for example, the results of the behavior recognition of the camera 1 and the camera 3 may be integrated.

Furthermore, the method for integrating the results of the behavior recognition is not limited to the above, and the behavior recognition result integration unit 105 may calculate a final score (that is, the final integration result) by using a statistical value such as the average value, variance, or median value of the scores, the average of the top K scores (topK average), or the like.

Furthermore, in the above description, an identical integration result (that is, the identical score) is assigned to each of the persons with the identical IDs appearing in the images of the respective cameras. Instead, the behavior recognition result integration unit 105 may correct each of the scores of the persons for each camera based on the average value, variance, or the like of the scores, and use the corrected scores as integration results. For example, regarding the results of the behavior recognition of the person with the ID “01” in FIG. 8, the behavior recognition result integration unit 105 corrects each of the scores “0.4”, “0.3”, and “0.9” estimated from the captured images of the respective cameras, in consideration of the magnitude of the variance. Then, the corrected scores are set as the integration results. As described above, the behavior recognition result integration unit 105 may assign different scores even to persons with the identical IDs for the respective camera.

In the above configuration, the multi-camera image acquisition unit 101 is an example of multi-camera image acquisition means, the person region detection unit 102 is an example of person detection means, the behavior recognition unit 103 is an example of person behavior recognition means, the inter-camera person integration unit 104 is an example of inter-camera person integration means, and the behavior recognition result integration unit 105 is an example of behavior recognition result integration means.

### Behavior Recognition Integration Processing

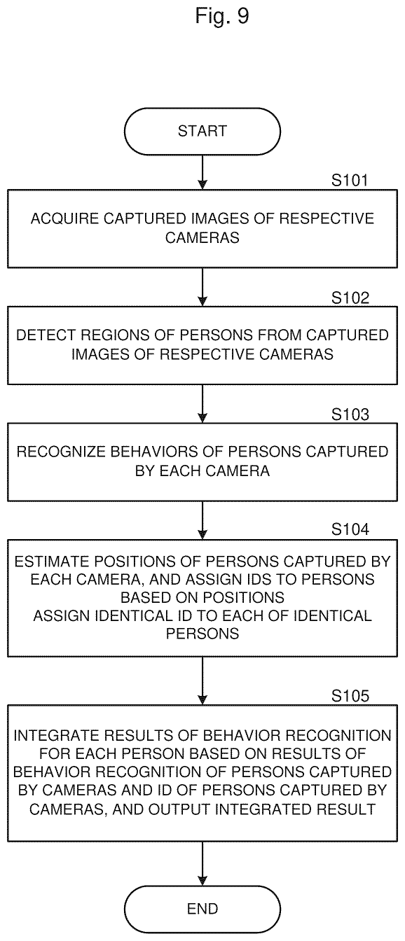

Next, processing of integrating results of the behavior recognition as described above will be described. FIG. 9 is a flowchart of behavior recognition integration processing of the image processing device 10. This processing is achieved by the processor 12 illustrated in FIG. 3 executing a program prepared in advance and operating as each element illustrated in FIG. 4.

First, the multi-camera image acquisition unit 101 acquires captured images of the respective cameras from the camera 1, the camera 2, and the camera 3 (step S101). The multi-camera image acquisition unit 101 outputs the captured images of the respective cameras to the person region detection unit 102.

Next, the person region detection unit 102 detects the regions of the persons from the captured images of the respective cameras (step S102). The person region detection unit 102 surrounds the region of each detected person with a rectangle or the like, and outputs the captured images of the respective cameras and the rectangle information thereof to the behavior recognition unit 103 and the inter-camera person integration unit 104. Next, the behavior recognition unit 103 recognizes the behaviors of the persons captured by each camera (step S103). The behavior recognition unit 103 outputs results of the behavior recognition to the behavior recognition result integration unit 105.

Next, the inter-camera person integration unit 104 estimates the positions of the persons captured by each camera, and assigns IDs to the persons based on the positions. The inter-camera person integration unit 104 assigns an identical ID to each of the identical persons (step S104). The inter-camera person integration unit 104 outputs the positions of the persons and the IDs of the persons to the behavior recognition result integration unit 105.

Next, based on the results of the behavior recognition of the persons captured by the cameras and the IDs of the persons captured by the cameras, the behavior recognition result integration unit 105 integrates the results of the behavior recognition for each person, and outputs the integrated result (step S105). Then, the processing ends.

### Modification

Next, modified examples of the first example embodiment will be described. The following modified examples can be appropriately combined and applied to the first example embodiment.

### Modification 1

The behavior recognition result integration unit 105 may integrate the results of the behavior recognition based on the orientations of the person with respect to the cameras. The behavior recognition result integration unit 105 calculates directions of the person with respect to the respective cameras, and obtains degrees to which the person faces the front. Then, the behavior recognition result integration unit 105 sets the degrees to which the person faces the front as reliability scores of the results of the behavior recognition. That is, the behavior recognition result integration unit 105 estimates that the reliability score of the result of the behavior recognition increases as the direction of the person is closer to the front. The behavior recognition result integration unit 105 adopts, as a final integration result, a result having the highest reliability score among the results of behavior recognition of the persons with identical IDs appearing in the images of the respective cameras.

Note that the behavior recognition result integration unit 105 can calculate a direction of a person with respect to a camera based on the skeleton of the person. The skeleton of the person can be estimated from the captured images of the respective cameras by using a model based on deep learning, for example. For example, in a case where the skeleton of the person is estimated two-dimensionally, the behavior recognition result integration unit 105 calculates a two-dimensional vector indicating the direction of the shoulder from the positions of the right shoulder and the left shoulder of the person. Then, the behavior recognition result integration unit 105 calculates an inner product of a vector indicating the direction of the shoulder and a vector (that is, the unit vector (1,0) in the x-axis direction) serving as a reference indicating the front direction, and obtains the direction of the person with respect to the camera. Specifically, the behavior recognition result integration unit 105 can estimate that the person faces the front more as the inner product is closer to zero. Furthermore, in a case where the skeleton of a person is estimated three-dimensionally, the behavior recognition result integration unit 105 calculates a cross product of a three-dimensional vector indicating the direction of the shoulder and a three-dimensional vector from the midpoint of the shoulder to the point of the head. The behavior recognition result integration unit 105 sets the calculated cross product vector as a direction vector indicating the orientation of the skeleton. Then, the behavior recognition result integration unit 105 calculates an inner product of the cross product vector and the camera vector. The camera vector is obtained by converting a vector from camera coordinates toward the image center of the camera into a vector in the world coordinate system. The behavior recognition result integration unit 105 can set a value obtained by multiplying the calculated inner product by −1 as the degree of facing the front. Specifically, the behavior recognition result integration unit 105 can estimate that the person is facing the front more as the value obtained by multiplying the inner product by −1 is closer to 1.

### Modification 2

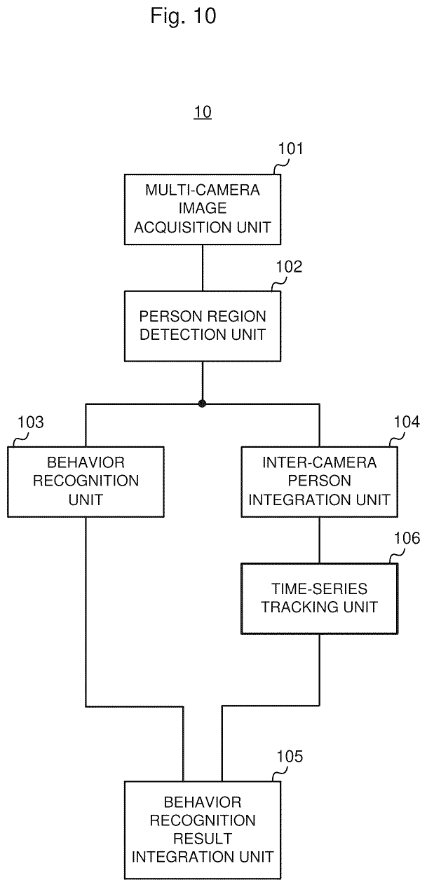

The behavior recognition result integration unit 105 may integrate the results of the behavior recognition using time-series information of a person. FIG. 10 is a block diagram illustrating a functional configuration of an image processing device 10 according to a modification 2. The functional configuration of FIG. 10 is based on the image processing device 10 according to the first example embodiment, but further includes a time-series tracking unit 106.

The positions of persons and the IDs of the persons are input to the time-series tracking unit 106 from the inter-camera person integration unit 104. The time-series tracking unit 106 can acquire time-series information by tracking each person. For example, the time-series tracking unit 106 tracks each person on a bird's-eye view in which the position of the person and the ID of the person are plotted. Examples of methods of the tracking include a method using a Kalman filter, a radar, or the like. The time-series tracking unit 106 outputs the tracking result of each person (time-series information of each person) to the behavior recognition result integration unit 105.

The behavior recognition result integration unit 105 performs statistical processing on the time-series information of each person. The behavior recognition result integration unit 105 can recognize, for example, a movement pattern of the person by statistical processing. The behavior recognition result integration unit 105 combines the result of the behavior recognition input from the behavior recognition unit 103 and the result of the statistical processing to determine the final result of the behavior recognition. As described above, the behavior recognition result integration unit 105 can perform the behavior recognition with high accuracy by using the time-series information.

### Modification 3

The inter-camera person integration unit 104 may correct the parameters of the cameras based on the results of the processing of the behavior recognition result integration unit 105.

In this case, the behavior recognition result integration unit 105 outputs the integration results of the behavior recognition to the inter-camera person integration unit 104. Then, the inter-camera person integration unit 104 corrects the input parameters of the cameras based on the integration results of the behavior recognition. For example, the inter-camera person integration unit 104 manually or automatically corrects the parameters of the cameras so that the positions of the persons having the identical result of the behavior recognition are made closer to each other in the bird's-eye view in which the positions of the persons are plotted.

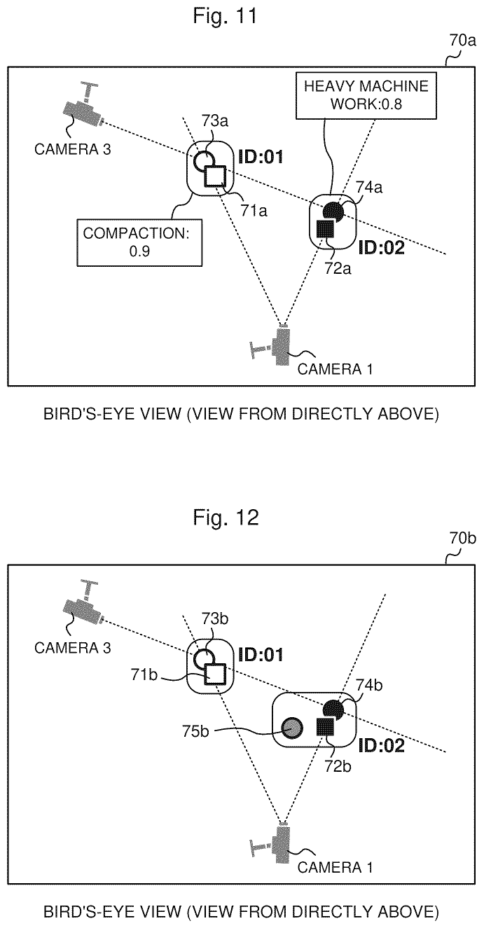

FIG. 11 is a diagram for describing a modification 3. In FIG. 11, the positions of the persons and the integration results of the behavior recognition are illustrated on a bird's-eye view 70a. The person 71a and the person 72a indicate positions of persons captured by the camera 1. The person 73a and the person 74a indicate positions of persons captured by the camera 3. From FIG. 11, the inter-camera person integration unit 104 corrects the parameters of the cameras so that the person 71a and the person 73a having the identical result of the behavior recognition are made closer to each other. In addition, the inter-camera person integration unit 104 corrects the parameters of the cameras so that the person 72a and the person 74a having the identical result of the behavior recognition are made closer to each other.

Using the corrected parameters allows the inter-camera person integration unit 104 to estimate the positions of the persons so that the persons in the correspondence relationship are made closer to each other. As a result, when the inter-camera person integration unit 104 determines whether the persons are an identical person, the possibility of erroneous association is reduced, resulting in improved accuracy of processing of the behavior recognition result integration unit 105.

### Modification 4

The behavior recognition result integration unit 105 may feed back the result of processing to the inter-camera person integration unit 104. The inter-camera person integration unit 104 reflects the content of the feedback in the result of processing and gives output to the behavior recognition result integration unit 105 again.

For example, in a case where the accuracy of the integration result is lowered when the integration is performed with the result of the behavior recognition of the person at a certain position, the behavior recognition result integration unit 105 may feed back to the inter-camera person integration unit 104 to remove the corresponding position information.

FIG. 12 is a diagram for describing a modification 4. In FIG. 12, the positions (persons 71b to 75b) of the persons are illustrated on a bird's-eye view 70b. In the person 72b, the person 74b, and the person 75b to which the ID02 is assigned, in a case where the result of the behavior recognition of the person 75b is greatly different from the results of the behavior recognition of the person 72b and the person 74b, the behavior recognition result integration unit 105 feeds back to the inter-camera person integration unit 104 to remove the person 75b.

As described above, on the bird's-eye view, by removing, in advance, the point that is greatly different from surrounding persons in the result of behavior recognition, it is possible to improve the accuracy of processing of the inter-camera person integration unit 104.

### Second Example Embodiment

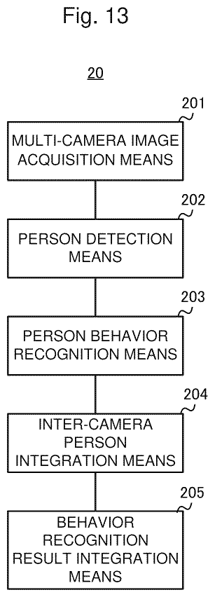

FIG. 13 is a block diagram illustrating a functional configuration of an image processing device according to a second example embodiment. The image processing device 20 includes multi-camera image acquisition means 201, person detection means 202, a person behavior recognition means 203, an inter-camera person integration means 204, and a behavior recognition result integration means 205.

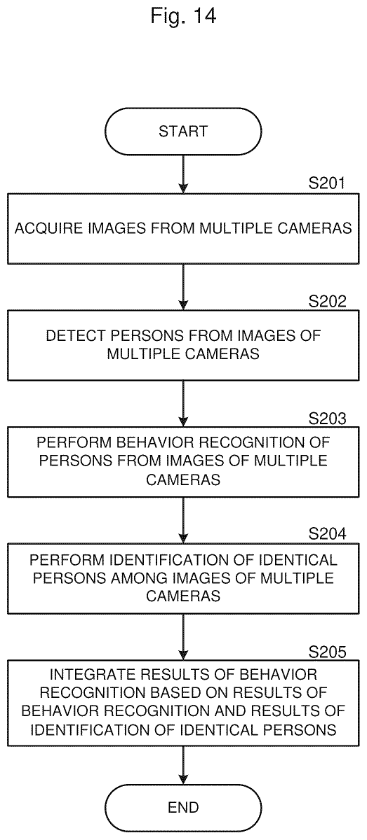

FIG. 14 is a flowchart of processing of the image processing device according to the second example embodiment. The multi-camera image acquisition means 201 acquires images from multiple cameras (step S201). The person detection means 202 detects persons from the images of the multiple cameras (step S202). The person behavior recognition means 203 performs behavior recognition of the persons from the images of the multiple cameras (step S203). The inter-camera person integration means 204 performs identification of identical persons among the images of the multiple cameras (step S204). The behavior recognition result integration means 205 integrates the results of the behavior recognition based on the results of the behavior recognition and the results of the identification of the identical persons (step S205).

The multi-camera image acquisition means 201 can be achieved by using the multi-camera image acquisition unit 101 according to the first example embodiment. The person detection means 202 can be achieved using the person region detection unit 102 according to the first example embodiment. The person behavior recognition means 203 can be achieved using the behavior recognition unit 103 according to the first example embodiment. The inter-camera person integration means 204 can be achieved using the inter-camera person integration unit 104 according to the first example embodiment. The behavior recognition result integration means 205 can be achieved by using the behavior recognition result integration unit 105 according to the first example embodiment.

According to the image processing device of the second example embodiment, it is possible to accurately execute the behavior recognition of the persons appearing in the images.

Some or all of the example embodiments described above may also be described as, but are not limited to, the following Supplementary Notes.

### Supplementary Note 1

An image processing device including:
multi-camera image acquisition means for acquiring images from multiple cameras;
person detection means for detecting persons from the images of the multiple cameras;
person behavior recognition means for performing behavior recognition of the persons from the images of the multiple cameras;
inter-camera person integration means for performing identification of an identical person among the images of the multiple cameras; and
behavior recognition result integration means for integrating results of the behavior recognition based on the results of the behavior recognition and a result of the identification of the identical person.

### Supplementary Note 2

The image processing device according to Supplementary Note 1, in which
the person behavior recognition means outputs a label and a score from each of the images of the multiple cameras, the labels and the scores serving as the results of the behavior recognition, and
the behavior recognition result integration means integrates the results of the behavior recognition based on multiple scores output from the person behavior recognition means.

### Supplementary Note 3

The image processing device according to Supplementary Note 2, in which the behavior recognition result integration means selects a highest score among the multiple scores as an integration result of behavior recognition.

### Supplementary Note 4

The image processing device according to Supplementary Note 1, in which the behavior recognition result integration means calculates a direction of each of the persons with respect to each of the multiple cameras from each of the images of the cameras, to obtain a reliability score, and integrates the results of the behavior recognition based on the reliability scores.

### Supplementary Note 5

The image processing device according to Supplementary Note 1, further including time-series tracking means that tracks the persons and acquires time-series information of the persons,
in which the behavior recognition result integration means performs statistical processing on the time-series information, and integrates the results of the behavior recognition based on the results of the behavior recognition, the result of the identification of the identical person, and a result of the statistical processing.

### Supplementary Note 6

The image processing device according to Supplementary Note 1, in which
the inter-camera person integration means includes:
a camera parameter acquisition means for acquiring parameters of the multiple cameras;
a plane estimation means for estimating a plane in a three-dimensional space;
a three-dimensional person position estimation means for estimating positions of the persons in the three-dimensional space based on regions of the persons detected from the images of the multiple cameras, the parameters of the cameras, and the plane in the three-dimensional space; and
a person matching processing means for performing identification of an identical person based on the estimated positions of the persons.

### Supplementary Note 7

The image processing device according to Supplementary Note 6, in which
the behavior recognition result integration means outputs an integration result of behavior recognition to the inter-camera person integration means, and
the inter-camera person integration means corrects the parameters of the cameras based on the integration result of the behavior recognition.

### Supplementary Note 8

The image processing device according to Supplementary Note 6, in which, in a case where accuracy is lowered when the results of the behavior recognition are integrated, the behavior recognition result integration means feeds back to the inter-camera person integration means in such a way as to remove a factor of lowering accuracy.

### Supplementary Note 9

The image processing device according to Supplementary Note 2, in which the behavior recognition result integration means integrates results of the behavior recognition by using at least one of an average value, a median value, and a topK average of the multiple scores.

### Supplementary Note 10

The image processing device according to Supplementary Note 6, in which the person matching processing means sequentially selects two cameras at a time from the multiple cameras and obtains a Euclidean distance between positions of two persons estimated from images of the two cameras, and performs identification of an identical person based on the Euclidean distance.

### Supplementary Note 11

An image processing method executed by a computer, the image processing method including:
acquiring images from multiple cameras;
detecting persons from the images of the multiple cameras;
performing behavior recognition of the persons from the images of the multiple cameras;
performing identification of an identical person among the images of the multiple cameras; and
integrating results of the behavior recognition based on the results of the behavior recognition and a result of the identification of the identical person.

### Supplementary Note 12

A program including causing a computer to execute processing of:
acquiring images from multiple cameras;
detecting persons from the images of the multiple cameras;
performing behavior recognition of the persons from the images of the multiple cameras;
performing identification of an identical person among the images of the multiple cameras; and
integrating results of the behavior recognition based on the results of the behavior recognition and a result of the identification of the identical person.

In addition, some or all of the configurations described in the Supplementary Notes 2 to 10 dependent on the Supplementary Note 1 described above can also be dependent on the Supplementary Notes 11 and 12 by a dependency relationship similar to the Supplementary Notes 2 to 10. Furthermore, some or all of the configurations described as the Supplementary Notes can be similarly dependent on not only the Supplementary Notes 1, 11, and 12, but also various pieces of hardware and software, and various recording means or systems for recording software without departing from the above-described example embodiments.

While the present disclosure has been particularly shown and described with reference to example embodiments and examples thereof, the present disclosure is not limited to these example embodiments and examples. It will be understood by those of ordinary skill in the art that various changes in form and details may be made therein without departing from the spirit and scope of the present disclosure as defined by the claims.

### DESCRIPTION OF SYMBOLS

10 image processing device
101 multi-camera image acquisition unit
102 person region detection unit
103 behavior recognition unit
104 inter-camera person integration unit
105 behavior recognition result integration unit
106 time-series tracking unit
141 camera parameter input unit
142 plane estimation unit
143 3D person position estimation unit
144 person matching processing unit

1. An image processing device comprising:
at least one memory configured to store instructions; and
at least one processor configured to execute the instructions to:
acquire images from multiple cameras;
detect persons from the images of the multiple cameras;
perform behavior recognition of the persons from the images of the multiple cameras;
perform identification of an identical person among the images of the multiple cameras; and
integrate results of the behavior recognition based on the results of the behavior recognition and a result of the identification of the identical person.

2. The image processing device according to claim 1, wherein
the one or more processors output a label and a score from each of the images of the multiple cameras, the labels and the scores serving as the results of the behavior recognition, and
the one or more processors integrate the results of the behavior recognition based on multiple scores.

3. The image processing device according to claim 2, wherein the one or more processors select a highest score among the multiple scores as an integration result of behavior recognition.

4. The image processing device according to claim 1, wherein the one or more processors calculate a direction of each of the persons with respect to each of the multiple cameras from each of the images of the cameras, to obtain a reliability score, and integrate the results of the behavior recognition based on the reliability scores.

5. The image processing device according to claim 1, the one or more processors are further configured to:
track the persons and acquire time-series information of the persons,
wherein the one or more processors perform statistical processing on the time-series information, and integrate the results of the behavior recognition based on the results of the behavior recognition, the result of the identification of the identical person, and a result of the statistical processing.

6. The image processing device according to claim 1, wherein
the one or more processors are further configured to:
acquire parameters of the multiple cameras;
estimate a plane in a three-dimensional space;
estimate positions of the persons in the three-dimensional space based on regions of the persons detected from the images of the multiple cameras, the parameters of the cameras, and the plane in the three-dimensional space; and
perform identification of an identical person based on the estimated positions of the persons.

7. The image processing device according to claim 6, wherein
the one or more processors correct the parameters of the cameras based on an integration result of the behavior recognition.

8. The image processing device according to claim 6, wherein, in a case where accuracy is lowered when the results of the behavior recognition are integrated, the one or more processors provide feedback to cause removal of a factor of lowering accuracy.

9. The image processing device according to claim 2, in which the one or more processors integrate results of the behavior recognition by using at least one of an average value, a median value, and a topK average of the multiple scores.

10. The image processing device according to claim 6, in which the one or more processors sequentially select two cameras at a time from the multiple cameras and obtain a Euclidean distance between positions of two persons estimated from images of the two cameras, and perform identification of an identical person based on the Euclidean distance.

11. An image processing method executed by a computer, the image processing method comprising:
acquiring images from multiple cameras;
detecting persons from the images of the multiple cameras;
performing behavior recognition of the persons from the images of the multiple cameras;
performing identification of an identical person among the images of the multiple cameras; and
integrating results of the behavior recognition based on the results of the behavior recognition and a result of the identification of the identical person.

12. A non-transitory computer readable recording medium recording a program for causing a computer to execute processing comprising:
acquiring images from multiple cameras;
detecting persons from the images of the multiple cameras;
performing behavior recognition of the persons from the images of the multiple cameras;
performing identification of an identical person among the images of the multiple cameras; and
integrating results of the behavior recognition based on the results of the behavior recognition and a result of the identification of the identical person.
